(19) United States
(12) Patent Application Publication
(10) Pub. No.: US 2025/0345833 A1
(43) Pub. Date: Nov. 13, 2025

(54) AN APPARATUS FOR CLEANING A MIXING DRUM OF READY-MIXED CONCRETE TRUCK

(71) Applicant: Min Su LEE, Incheon (KR)

(72) Inventor: Min Su LEE, Incheon (KR)

(21) Appl. No.: 18/866,894

(22) PCT Filed: Jul. 19, 2023
(86) PCT No.: PCT/KR2023/010406

§ 371 Date: Nov. 18, 2024

(30) Foreign Application Priority Data
Aug. 30, 2022 (KR) 10-2022-0109053

(51) Int. Cl. B08B 9/08; B28C 5/42

(52) U.S. Cl. CPC B08B 9/0813; B28C 5/4272

(57) ABSTRACT

The invention is an apparatus for cleaning a mixing drum of ready-mixed concrete truck comprising: a multi-stage arm 10 which is telescopically extendable and has a base portion mounted on the periphery of a hopper 4 and is selectively positioned inside or outside a mixing drum 2; a traction wire 13 which extends parallel to the multi-stage arm 10; a winch mechanism 12 which releases or pulls the traction wire 13 to extend or contract the multi-stage arm 10; and a washing water nozzle 20 which is arranged at the front end of the multi-stage arm 10 and moves together with it and sprays washing water toward the front, side, and rear.

### TECHNICAL FIELD

The present invention relates to an apparatus for cleaning a mixing drum of ready-mixed concreate truck, and more specifically, to an apparatus for cleaning a mixing drum of ready-mixed concreate truck having a novel structure that is simple in structure but can efficiently and cleanly clean the inside of a mixing drum of a ready-mixed concrete vehicle and is also easy to store and accommodate.

### BACKGROUND ART

Raw concrete used for pouring concrete at construction sites is generally prepared by mixing aggregate, cement, water, and other materials in a predetermined mixing ratio at a ready-mixed concrete manufacturing facility, then placing it in the mixing drum of a ready-mixed concrete vehicle, rotating the mixing drum to stir the ready-mixed concrete, and transporting it to the site, where it is then poured at the site.

These ready-mixed concrete vehicles contain raw concrete that hardens rapidly over time. If the concrete hardens while attached to the mixing drum, hopper, or chute of the ready-mixed concrete vehicle, the ready-mixed concrete vehicle will not be able to function properly. Therefore, once the raw concrete has been poured out at the site, the raw concrete attached to the inside of the mixing drum, hopper, chute, or body of the drum must be washed and removed.

However, in the past, in order to clean the inside of a ready-mixed concrete vehicle, a method was used in which cleaning water was filled inside the mixing drum, the mixing drum was rotated, and the raw concrete attached to the inner wall of the mixing drum or the screw blades installed in a spiral shape on the inner surface of the drum was removed, and the cleaning water was sprayed using a nozzle from the hopper side, which is the inlet. However, by simply filling the mixing drum with cleaning water and rotating it, the concrete attached to the inner wall of the mixing drum or the screw blades is not easily removed, and even if pressurized cleaning water is injected using a nozzle from the hopper side, the spray pressure of the cleaning water does not reach the raw concrete remaining on the back surface of the screw blade or the inner wall of the drum adjacent to the back surface when viewed from the inlet of the mixing drum, and thus the concrete still remains and hardens on the inner wall of the drum or the back surface of the screw blades. Because of this, the function of the mixing drum, which is to contain concrete materials and mix and discharge them quickly, is impaired, so the driver has to go inside the mixing drum and use a tool to strike and remove the hardened concrete attached to the inner wall of the mixing drum or the screw blades, which is inconvenient, and in the process, the mixing drum or screw blades can be damaged, which shortens the lifespan of the ready-mixed concrete vehicle.

### DISCLOSURE

### Technical Problems

The present invention has been proposed in consideration of the maintenance problems, such as cleaning, of the mixing drum of a conventional ready-mixed concrete vehicle as described above, and the object of the present invention is to provide a mixing drum washing device for a ready-mixed concrete vehicle of a novel structure, which is simple in structure but can efficiently and cleanly clean the inside of the mixing drum of a ready-mixed concrete vehicle and is also easy to store and accommodate.

### Technical Solution

According to one feature of the present invention, there is provided an apparatus for cleaning a mixing drum of ready-mixed concreate truck, wherein a rotatable mixing drum 2 is loaded on or towed by the ready-mixed concrete vehicle 1 and includes a hopper 4 into which ready-mixed concrete mixed in a ready-mixed concrete plant is fed, screw blades 5 arranged in a spiral shape along an inner wall circumference of it, and a chute 6 through which mixed ready-mixed concrete is discharged, characterized in that;

the rotatable mixing drum 2 includes a multi-stage arm 10 whose base end is mounted on the circumference of the hopper 4 and is selectively positioned inside or outside the mixing drum 2 and is telescopically extendable, a traction wire 13 extending parallel to the multi-stage arm 10, a winch mechanism 12 that releases or pulls the traction wire 13 to extend or contract the multi-stage arm 10, and a washing water nozzle 20 that is arranged at the tip of the multi-stage arm 10 and moves together and sprays washing water toward the front, side, and rear.

According to another feature of the present invention, there is provided an apparatus for cleaning a mixing drum of ready-mixed concreate truck, wherein the multi-stage arm 10 is formed of a plurality of watertight and retractable pipes, to one end of which the washing water nozzle 20 is directly coupled, or a separate washing water line 16 is arranged inside or outside the multi-stage arm 10, and the washing water nozzle 20 is coupled to one end of the washing water line 16.

According to another feature of the present invention, there is provided an apparatus for cleaning a mixing drum of ready-mixed concreate truck, wherein the base portion of the multi-stage arm 10 is provided with a rotation shaft 11 mounted on the periphery of the hopper 4, and the multi-stage arm 10 is positionally adjusted between a first position in which it extends downward in a contracted state toward the outside of the hopper 4 around the rotation shaft 11, and a second position in which it extends into the inside of the mixing drum 2 through the opening 8 of the hopper 4.

### Advantageous Effect

According to the present invention, a vehicle-integrated ready-mixed concrete mixing drum washing device is provided, in which a base portion of a flexible multi-stage arm 10 is mounted on the periphery of a hopper 4 of a mixing drum 2 of a ready-mixed concrete vehicle 1, and the multi-stage arm 10 is selectively positioned inside or outside the mixing drum 2, and a washing water nozzle 20 for spraying washing water forward or backward is provided at the tip of the multi-stage arm 10, so that the mixing drum of the ready-mixed concrete vehicle can be washed at any time when necessary without having to move to a ready-mixed concrete manufacturing plant or construction site where a mixing drum washing apparatus is installed as a separate facility, so that the fresh concrete remaining in the mixing drum 2 is quickly washed so as not to stick, and the mixing drum 2 of the ready-mixed concrete vehicle 1 can be kept clean and durable. In addition, when not being used, the multi-stage arm 10 of the washing device is withdrawn to the outside of the mixing drum 2 so as not to interfere with the feeding of ready-mixed concrete into the mixing drum 2 through the hopper 4 at the ready-mixed concrete plant, the moving of the mixing drum while rotating, or the discharge of ready-mixed concrete from the field through the chute 6, and when washing, the multi-stage arm 10 is positioned and fed into the mixing drum 2 for washing, thereby increasing the convenience of washing by integrating the washing device into the ready-mixed concrete vehicle, and when loading or injecting ready-mixed concrete, the washing device is withdrawn to the outside of the mixing drum 2 so as not to interfere with the feeding or on-site injection of ready-mixed concrete, and also prevents such concrete from attaching to the washing nozzle of the washing device, causing the washing device to malfunction, thereby enabling the washing device to be used for a long period of time without breakdown, thereby increasing the durability of the washing device.

In addition, when washing, the multi-stage arm 10 is extended to spray washing water inside the mixing drum 2, and by spraying the washing water not only forward and sideways but also backward, the concrete remaining in the dead space around the back of the screw blade 5 or the surrounding area where the washing water does not reach when spraying the washing water forward is removed by the water pressure of the washing water and discharged together with the washing water through the discharge port 8, so that the inside of the mixing drum 2 can be cleaned cleanly, and accordingly, the function of the ready-mixed concrete vehicle can be prevented from being damaged or the durability from being reduced.

In addition, the multi-stage arm 10 is made of a plurality of watertight and retractable pipes, and a washing water nozzle 20 is connected to the tip of the multi-stage arm 10, or a washing water line 16 such as a hose or the like, which is separately provided inside or outside the multi-stage arm 10 and stretches along the length of the multi-stage arm 10, so that with a simple structure, the washing water line 16 follows the extension and contraction of the multi-stage arm 10 and is stretched, sagged, or pulled to move accordingly, so that the washing water can be sprayed not only on the front but also on the rear of the screw blade 5 at any position while moving back and forth inside the mixing drum 2, thereby effectively and cleanly washing it.

In addition, the base of the multi-stage arm 10 is provided with a rotation shaft 11 mounted on the circumference of the hopper 4, and the multi-stage arm 10 is positionally adjusted between a first position in which it extends downward in a contracted state to the outside of the hopper 4 with the rotation shaft 11 as the center, and a second position in which it extends into the inside of the mixing drum 2 through the opening 8 of the hopper 4, so that the multi-stage arm 10 is extended downward in a contracted state from the circumference of the hopper 4 so as not to interfere with other parts when loading or moving ready-mixed concrete or when discharging ready-mixed concrete at the site, and when washing, it is extended into the inside of the mixing drum 2 through the opening 8 of the hopper 4, thereby providing a compact and easy-to-store and storage mixing drum washing device for a ready-mixed concrete vehicle.

### DESCRIPTION OF THE DRAWING

FIG. 1 is a front view of one embodiment of the present invention.

FIG. 2 is a cross-sectional view of the mixing drum in the state of use of the above embodiment.

FIG. 3 is a perspective view of the multi-stage arm of the above embodiment.

### DETAILED DESCRIPTION OF THE INVENTION

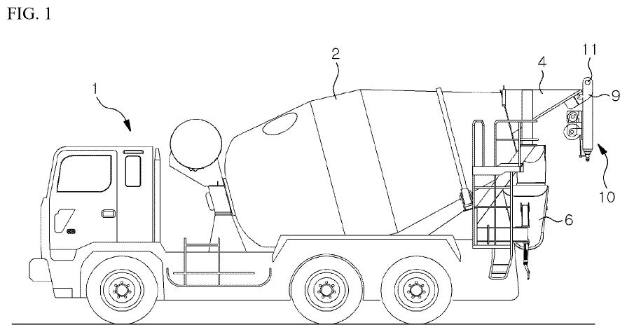

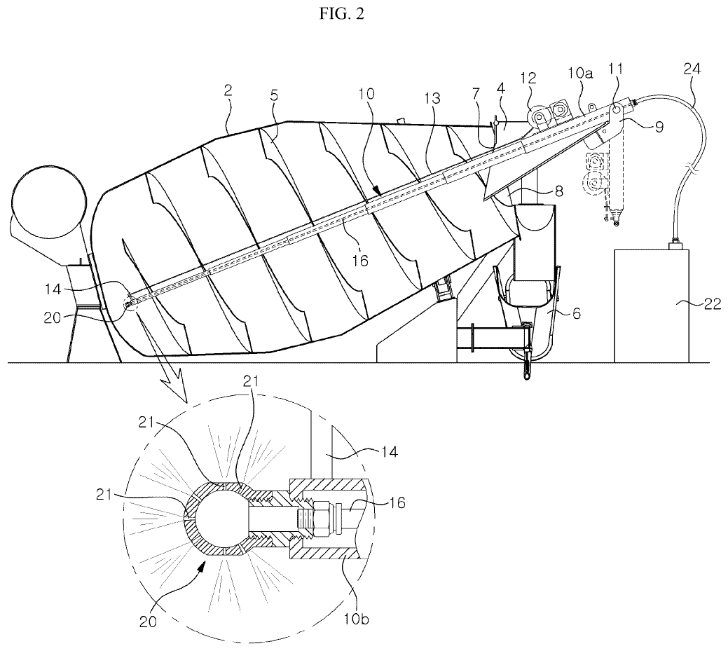

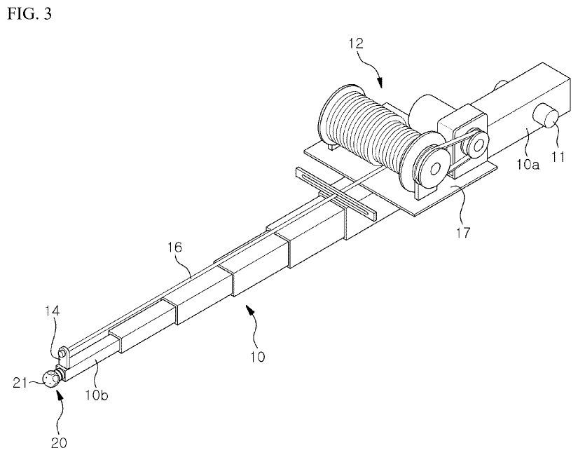

Hereinafter, preferred embodiments of the present invention will be described with reference to the drawings. FIG. 1 is a front view of one embodiment of the present invention, FIG. 2 is a cross-sectional view of a mixing drum in a state of use, and FIG. 3 is a perspective view of a multi-stage arm. As illustrated, according to the present invention, a ready-mixed concrete vehicle 1 is rotatably equipped with a mixing drum 2 including a hopper 4 into which ready-mixed concrete mixed in a ready-mixed concrete plant is fed, screw blades 5 arranged in a spiral shape along an inner wall of it, and a chute 6 through which mixed ready-mixed concrete is discharged.

A bracket 9 is mounted on the circumference of the above hopper 4, and a rotation shaft 11 is coupled to the bracket 9, and a base portion of a multi-stage arm 10 composed of a plurality of pipes that telescopically extend like a multi-stage boom is rotatably coupled to the rotation shaft 11. In addition, a winch mechanism 12 mounted on a support plate 17 is provided on the outer surface of a first arm 10a arranged on the base portion of the multi-stage arm 10. The winch mechanism 12 is composed of a motor, a reducer, and a pulley or drum, and can extend or contract the multi-stage arm 10 by winding or releasing a traction wire 13 that is connected to the foremost arm 10b through a ring 14 or hook that is installed to be aligned on the outer surface of the multi-stage arm 10. This multi-stage arm 10 can be extended by its own weight and contracted by the pulling of the traction wire 13, but, depending on the structure of the winch mechanism 12 or the arrangement of the traction wire 13, both the extension and contraction of the multi-stage arm 10 can be performed by adjusting the pushing or pulling direction of the traction wire 13.

A washing water nozzle 20 is provided at the tip of this multi-stage arm 10. Nozzle holes 21 for spraying washing water toward the front, side, and rear are formed in this washing water nozzle 20. Here, the forward, side, and rear refer to the direction in which the multi-stage arm 10 extends as the front, and the direction in which it contracts as the rear, and they may include an inclined front or an inclined rear. In this way, since the present invention can spray the washing water in all directions around the periphery of the washing water nozzle 20, including the front, side, and rear. Conventionally as the washing water is sprayed forward toward the inside of the drum near the inlet 7 of the hopper 4 facing the entrance of the mixing drum 2, the concrete remaining in the dead space around or on the back surface of the screw blade 5 that the washing water does not reach through the rear nozzle hole 21 of the washing water nozzle 20. But according to the present invention, it can be removed by the water pressure of the washing water and discharged together with the washing water through the discharge port 8, thereby making it possible to cleanly wash the inside of the mixing drum 2, and thereby preventing the function of the ready-mixed concrete vehicle from being damaged or the durability from being reduced.

In addition, according to the present invention, the multi-stage arm 10 may be configured such that a plurality of pipes that expand and contract in a telescopic manner are water-tightly joined together via a sealing ring (not shown), so that the multi-stage arm 10 itself may function as an expandable washing water supply pipe. However, in the illustrated embodiment, a washing water line 16 formed of a flexible hose is built into the multi-stage arm 10 formed of a plurality of pipes, and the washing water nozzle 20 described above is connected to the tip of the washing water line 16. Accordingly, as the multi-stage arm 10 expands and contracts, the washing water line 16 built into the multi-stage arm 10 also expands and contracts accordingly. On the other hand, unlike this, the washing water line 16 does not expand along the longitudinal direction inside the multi-stage arm 10, buy it can be formed of a single flexible hose or tube and disposed outside and along the multi-stage arm 10, so that the washing water line 16 may also be pulled or stretched forward and backward as the multi-stage arm 10 expands and contracts. This washing water line 16 is connected to the washing water supply device 22 and the washing water supply line 24 provided on the outside of the mixing drum 2. This washing water supply device 22 may be installed on the ready-mixed concrete vehicle 1 or provided separately.

In addition, according to the present invention, a bracket 9 is mounted on the base portion of the multi-stage arm 10 around the periphery of the hopper 4, and the base portion of the multi-stage arm 10 is rotatably arranged on the bracket 9 via a rotation axis 11. The multi-stage arm 10 is positionally adjusted between a first position in which it extends downwards in a contracted state to the outside of the hopper 4 around the rotation axis 11, and a second position in which it extends into the inside of the mixing drum 2 through the opening 8 of the hopper 4. And in the second position where the multi-stage arm 10 extends into the interior of the mixing drum 2, the multi-stage arm 10 can extend by the operation of the winch mechanism 12 or by its own weight to enter deep into the interior of the mixing drum 2 together with the washing water nozzle 20, and the interior of the mixing drum 2 can be cleaned by spraying washing water.

According to the present invention described above, the mixing drum of a ready-mixed concrete vehicle can be washed whenever necessary without having to move to a ready-mixed concrete manufacturing plant or construction site equipped with a mixing drum washing apparatus as a separate facility, so that the raw concrete remaining in the mixing drum 2 can be quickly washed, so it does not stick, thereby maintaining the mixing drum 2 of the ready-mixed concrete vehicle 1 clean and durable. In addition, when washing is not performed, the multi-stage arm 10 of the washing device is retracted to the outside of the mixing drum 2, so that the ready-mixed concrete is fed into the mixing drum 2 through the hopper 4 at the ready-mixed concrete plant, or while the mixing drum is rotated and moved, or while the ready-mixed concrete is discharged from the site through the chute 6, thereby preventing the concrete from attaching to the washing nozzle of the washing device and causing the washing device to malfunction, thereby enhancing the durability of the washing device.

1. An apparatus for cleaning a mixing drum of ready-mixed concreate truck, wherein a rotatable mixing drum (2) is loaded on or towed by the ready-mixed concrete vehicle (1) and includes a hopper (4) into which ready-mixed concrete mixed in a ready-mixed concrete plant is fed, screw blades (5) arranged in a spiral shape along an inner wall circumference of it, and a chute (6) through which mixed ready-mixed concrete is discharged, characterized in that;
the rotatable mixing drum (2) includes a multi-stage arm (10) whose base end is mounted on the circumference of the hopper (4) and is selectively positioned inside or outside the mixing drum (2) and is telescopically extendable, a traction wire (13) extending parallel to the multi-stage arm (10), a winch mechanism (12) that releases or pulls the traction wire (13) to extend or contract the multi-stage arm (10), and a washing water nozzle (20) that is arranged at the tip of the multi-stage arm (10) and moves together and sprays washing water toward the front, side, and rear, and that a rotary shaft (11) mounted on the circumference of a hopper (4) is provided at the base, and a multi-stage arm (10) is positionally adjusted between a first position in which it extends downwards in a contracted state to the outside of the hopper (4) around the rotary shaft (11), and a second position in which it extends into the inside of the mixing drum (2) through the opening (8) of the hopper (4).

2. An apparatus for cleaning a mixing drum of ready-mixed concreate truck of claim 1, wherein the multi-stage arm (10) is formed of a plurality of watertight and retractable pipes, to one end of which the washing water nozzle (20) is directly coupled, or a separate washing water line (16) is arranged inside or outside the multi-stage arm (10), and the washing water nozzle (20) is coupled to one end of the washing water line (16).
